(19) United States
(12) Patent Application Publication
(10) Pub. No.: US 2023/0229748 A1
(43) Pub. Date: Jul. 20, 2023

(54) Artificial Forensic Fingertip For Security Investigations

(71) Applicant: META PLATFORMS, INC., Menlo Park, CA (US)

(72) Inventors: Amin TermehYousefi, Santa Clara, CA (US); Ahmad Byagowi, Menlo Park, CA (US)

(21) Appl. No.: 18/061,190

(22) Filed: Dec. 2, 2022

Related U.S. Application Data
(60) Provisional application No. 63/301,145, filed on Jan. 20, 2022.

(51) Int. Cl. G06F 21/34; G02B 27/01

(52) U.S. Cl. CPC G06F 21/34; G02B 27/017; G02B 2027/0178

(57) ABSTRACT

Methods, apparatuses, and systems may detect the authentication status of hardware. A detector, such as artificial finger, may be used to probe certain sections of a product, such as a head mounted display. These certain sections may cause the artificial finger to generate a signal that is stored and then compared to predetermined signals associated with the certain section. Based on the comparison, an indication of authentication status may be provided and appropriate action taken.

### CROSS-REFERENCE TO RELATED APPLICATIONS

This application claims the benefit of U.S. Provisional Application No. 63/301,145 filed Jan. 20, 2022, entitled “Artificial Forensic Fingertip For Security Investigation,” the entire content of which is incorporated herein by reference.

### TECHNOLOGICAL FIELD

Exemplary embodiments of this disclosure relate generally to methods, apparatuses, or computer program products for detecting unauthentic products.

### BACKGROUND

Artificial reality is a form of reality that has been adjusted in some manner before presentation to a user, which may include, for example, a virtual reality, an augmented reality, a mixed reality, a hybrid reality, or some combination or derivative thereof. Artificial reality content may include completely computer-generated content or computer-generated content combined with captured (e.g., real-world) content. The artificial reality content may include video, audio, haptic feedback, or some combination thereof, any of which may be presented in a single channel or in multiple channels (such as stereo video that produces a three-dimensional (3D) effect to the viewer). Additionally, in some instances, artificial reality may also be associated with applications, products, accessories, services, or some combination thereof, that are used to, for example, create content in an artificial reality or are otherwise used in (e.g., to perform activities in) an artificial reality. Head-mounted displays (HMDs) including one or more near-eye displays may often be used to present visual content to a user for use in artificial reality applications.

But such HMDs and other associated equipment may be counterfeited. Such counterfeit products may be of low quality and should be taken off the market before they cause physical harm to the user, such as fires because of poor batteries or circuitry, or financial harm to the company that creates the original product. Counterfeiting of manufactured goods is a worldwide problem. There should be a way to effectively detect counterfeit products.

### BRIEF SUMMARY

Disclosed herein are methods, apparatuses, and systems that may provide the authentication status of hardware. A detector, such as an artificial finger, may be used to probe certain sections of hardware, such as a head mounted display. These certain sections may cause the artificial finger to generate a signal that is stored and then compared to predetermined signals associated with the certain section. Based on the comparison, an indication of authentication status may be provided and appropriate action taken.

In an example, a system may include an artificial finger for probing a surface of a hardware device and generates signals based on probing the surface of the hardware device; and an interpretation device communicatively coupled with the artificial finger and used to interpret the signals of the artificial finger.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

FIG. 1 illustrates an example head-mounted display (HMD) associated with artificial reality content.

FIG. 2 illustrates an exemplary use of an artificial finger.

FIG. 3 illustrates an exemplary method for using an artificial finger.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

It is to be understood that the methods and systems described herein are not limited to specific methods, specific components, or to particular implementations. It is also to be understood that the terminology used herein is for the purpose of describing particular embodiments only and is not intended to be limiting.

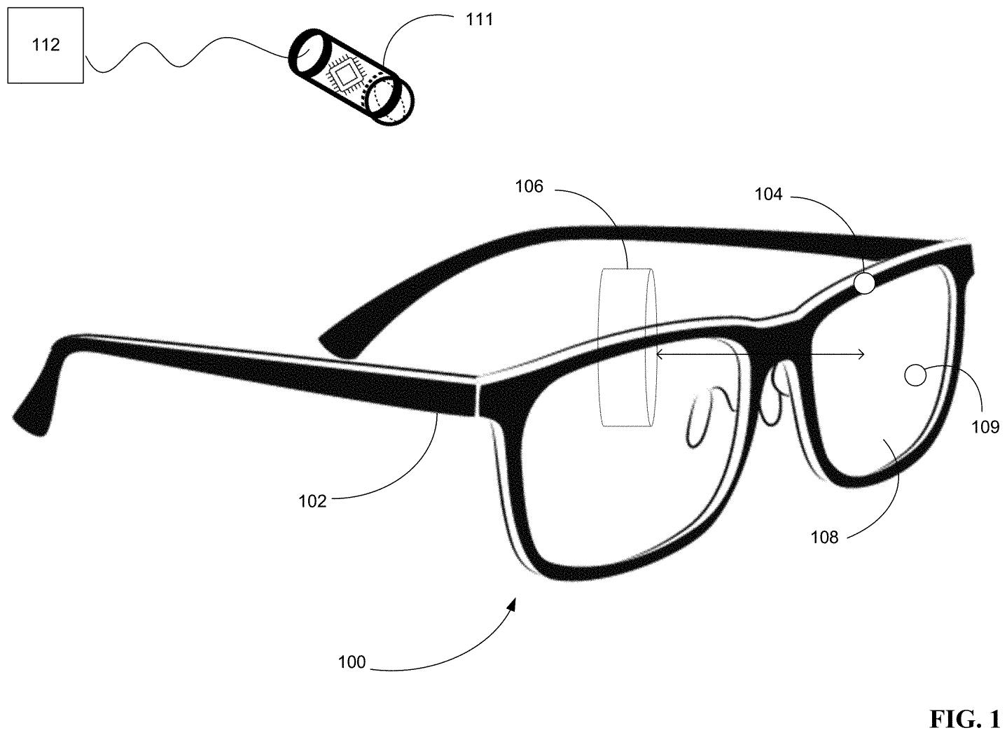

As shown in FIG. 1, HMD 100 including one or more near-eye displays may often be used to present visual content to a user for use in artificial reality applications. One type of near-eye display may include an enclosure 102 that houses components of the display or is configured to rest on the face of a user, such as for example a frame. The near-eye display may include a waveguide 108 that directs light from a light projector (not shown) to a location in front of the user's eyes.

Conventionally, hardware investigation is heavily based on a manual operation since automated methods lack complex smart sensing. A significant factor for successful forensic investigation may rely on a consistent measurement of a test device versus a golden unit. Conventional probing methods may lack the ability to replace human tactile sensing required to move manual forensic test methods toward automation.

The present disclosure is generally directed to systems and methods for detecting authentic or unauthentic devices (e.g., counterfeits). Examples in the present disclosure may include head-mounted displays 100 which may include an enclosure 102 with several subcomponents. Although HMD 100 may be used in the examples herein, it is contemplated that individual subcomponents of HMD 100 (e.g., waveguide, light projector, sensors, etc.), peripherals for HMD 100 (e.g., controllers), or hardware not related to HMD 100, may implement the disclosed authentication system.

FIG. 1 illustrates an example authentication system that include the use of a head-mounted display (HMD) 100 associated with artificial reality content. HMD 100 may include enclosure 102 (e.g., an eyeglass frame) or wave guide 108. Waveguide 108 may be configured to direct images to a user's eye. In some examples, head-mounted display 100 may be implemented in the form of augmented-reality glasses. Accordingly, the waveguide 108 may be at least partially transparent to visible light to allow the user to view a real-world environment through the waveguide 108. FIG. 1 also shows a representation of an eye 106 that may be a real or an artificial eye-like object that is for testing or using HMD 100. Artificial finger (AF) 111 (e.g., a detector) may be connected with interpretation device 112. As disclosed in more detail herein, interpretation device 112 may receive one or more signals from AF 111 when it is used to probe the surface of HDM 100. As shown, example points of significance may include area 104, which is on enclosure 102, or area 109, which is on waveguide 108.

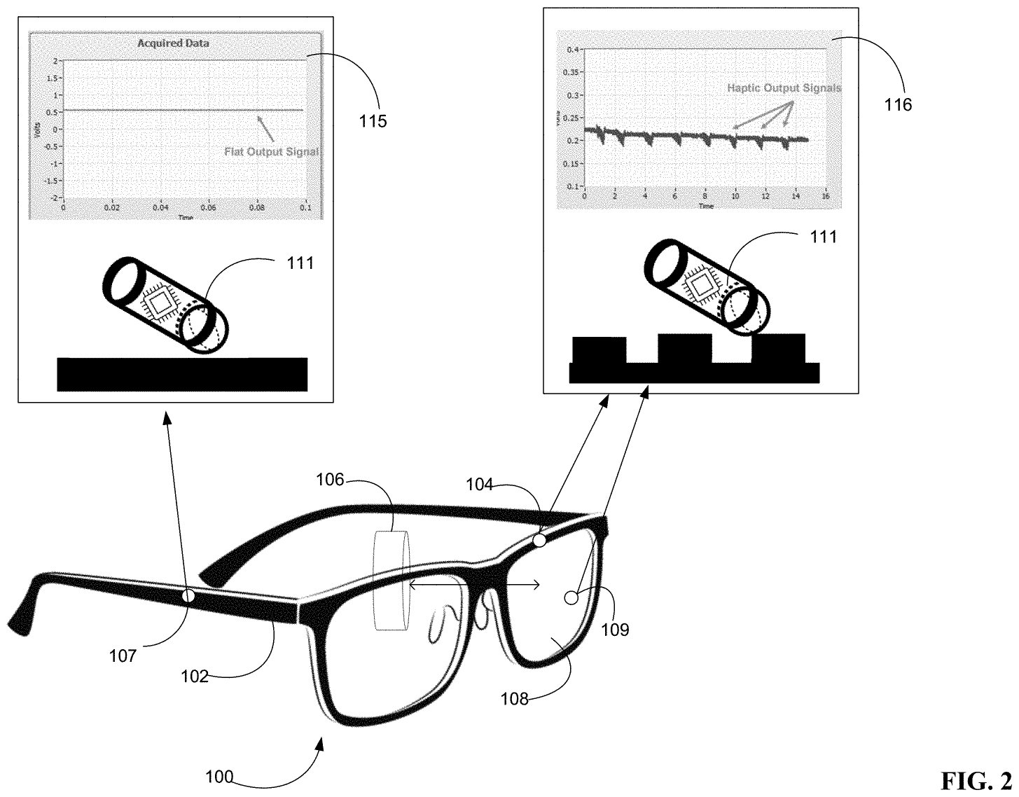

FIG. 2 illustrates an exemplary use of AF 111. Area 107 may be a normal area that does not have any mechanical difference or hardware security feature. Area 104, which is located on enclosure 102, or area 109, which is located on waveguide 108, may have a mechanical difference which would be indicative of a hardware security feature. It is contemplated that the mechanical differences in area 104 or area 109 may be on the micro, nano, or smaller scale and not usually perceptible by the unassisted human eye or touch.

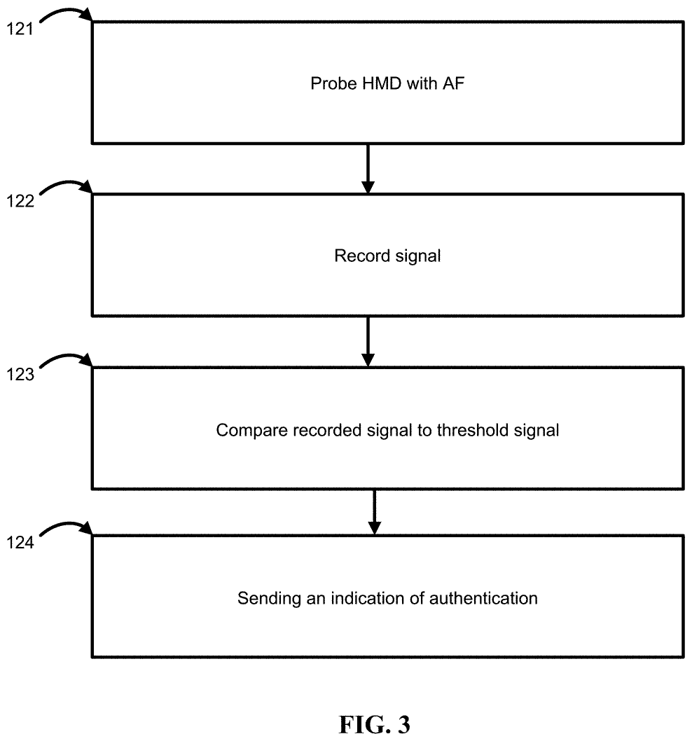

FIG. 3 illustrates an exemplary method for using AF 111. In an example, a tactical sensing method may be based on a piezo-resistive or electric pressure sensor. This method may be capable of operating in a high dynamic range with a sufficient limit of detection.

At step 121, probe AF 111 across HMD 100.

At step 122, record a first signal at area 104 as AF 111 is probed across HMD 100. The recorded signal may be displayed as shown in FIG. 2 at graph 115 or graph 116.

At step 123, compare the signal at area 104 to an expected signal. The expected signal may be based on an algorithm or the like and may be a closely guarded secret. The expected signal may be within a threshold amount. The comparison may be done by interpretation device 112, which may be a separate device or integrated into AF 111.

At step 124, based on the comparison, sending an indication of an authentication status associated with the signal at area 104. The indication may be an alert that is sent to a display. The alert may indicate authentic or unauthentic for HMD 100 (or a component) thereof.

The hemispherical artificial fingertip, AF 111, may be designed to generate periodical electromechanical signals while probing the digital device which may be utilized to find the stiffness, dimension, design, material, temperature, or weight of HMD 100 (or any other hardware).

A multiphase desperation method may be utilized to achieve well-homogeneous nanocomposites for AF 111, which may be used to receive a uniform signal from different parts of a thin film. In fact, by applying external stress to a nanocomposite, the initial resistance changes due to the involved electroconductive conjunctions, and the output resistivity may reach a new value.

AF 111 (which may be a hybrid piezo-resistive/electric based artificial fingertip) may be designed to receive the forensic signature of hardware. Sense of touch through generating electrical signals with respect to mechanical deformation is used in haptic systems. Among the established pressure sensors, nanocomposite-based piezo sensors may maintain a high sensing and stretchable performance due to the percolation network of electroconductive nanomaterials embedded in a dielectric polymer matrix.

Nanotubes (NTs) may be used as a filler of stretchable nanocomposite for piezo sensors due to their excellent electron conductivity. Furthermore, the sensitivity and limit of detection of the sensors are well-adjustable in the NTs-based haptic sensors. It may be done by manipulating the conductive pattern and the amount of NTs junctions in the nanocomposite.

Indications of authentication may not only be based on receiving a certain signal, but also where a signal is received on hardware. For example, a signal received by AF 111 for waveguide 108 that is expected to be received for enclosure 102 may indicate an unauthentic HMD 100 (or at least a part, such as waveguide 108).

The method may be iterative and continually compare signal changes associated with movement of AF 111 on HMD 100.

The foregoing description of the embodiments has been presented for the purpose of illustration; it is not intended to be exhaustive or to limit the patent rights to the precise forms disclosed. Persons skilled in the relevant art may appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which may be executed by a computer processor for performing any or all of the steps, operations, or processes described.

Embodiments also may relate to an apparatus for performing the operations herein. This apparatus may be specially constructed for the required purposes, or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

The language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A forensic security system comprising:
an artificial finger for probing a surface of a hardware device and generates signals based on probing the surface of the hardware device; and
an interpretation device communicatively coupled with the artificial finger.

2. The system of claim 1, wherein the interpretation device is used to compare generated signals from the artificial finger for the hardware device with expected signals from the artificial finger for the hardware device.

3. The system claim 1, wherein the artificial finger uses a piezo-resistive sensor or pressure sensor.

4. The system claim 1, wherein the artificial finger comprises a piezo-resistive sensor or pressure sensor.

5. The system claim 1, wherein the artificial finger comprises a piezo-resistive sensor.

6. The system claim 1, wherein the artificial finger comprises a piezo-resistive sensor and pressure sensor.

7. A method comprising:
receiving a first signal generated by an artificial finger when it probes a hardware device;
comparing the first signal to a second signal, wherein the second signal is predetermined.
determining that the first signal is different than the second signal;
based on the first signal being different than the second signal, sending an alert.

8. The method of claim 7, wherein the alert indicates that the hardware device is unauthentic.

9. The method of claim 7, wherein the alert indicates that the hardware device is authentic.

10. A method comprising:
receiving a first signal generated by an artificial finger when it probes a hardware device;
comparing the first signal to a second signal, wherein the second signal is predetermined.
determining that the first signal is the same as the second signal;
based on the first signal being the same as the second signal, sending an alert.

11. The method of claim 10, wherein the alert indicates that the hardware device is unauthentic.

12. The method of claim 10, wherein the alert indicates that the hardware device is authentic.

13. The method of claim 10, wherein the hardware is a head mounted display for artificial reality.
